(19) United States
(12) Patent Application Publication
(10) Pub. No.: US 2008/0281816 A1
(43) Pub. Date: Nov. 13, 2008

(54) Dynamic Keyword Processing System and Method For User Oriented Internet Navigation

(75) Inventor: June Whi Kim, Anyang Kyunggido (KR)

Correspondence Address: BROOKS KUSHMAN P.C., 1000 TOWN CENTER, TWENTY-SECOND FLOOR, SOUTHFIELD, MI, 48075, US

(73) Assignee: METANAV CORPORATION, Anyang Kyunggido (KR)

(21) Appl. No.: 10/596,136

(22) PCT Filed: Nov. 30, 2004
(86) PCT No.: PCT/KR04/03126

§ 371 Date: Jun. 1, 2006

(30) Foreign Application Priority Data
Dec. 1, 2003 (KR) 10-2003-0086187
Dec. 3, 2003 (KR) 10-2003-0087005
Dec. 3, 2003 (KR) 10-2003-0087315
Jan. 31, 2004 (KR) 10-2004-0006487

(51) Int. Cl. G06F 17/30

(52) U.S. Cl. 707/6; 707/E17.014

(57) ABSTRACT

A system and method are described that enable users to navigate on the web according to use's own keyword definition on web site, keyword extraction and processing from user's visiting website, user's selection on keyword categories, and mapping between E-mail address and URL. The user's own keyword definition on web site is user-driven keyword naming scheme is opposite) method of the keyword domain services which were service company-driven method. The user's selection on keyword categories provides users choice on keyword categories and group. The keyword extraction and processing from user's visiting web site provides keyword extraction from the page and arranges for related keywords in order to prepare for anticipated search and navigation from the user's current web site and keyword. The mapping system between E-mail and URL provides conversion of E-mail address into URL, in order to use as domain name.

### TECHNICAL FIELD

This invention is about the system and method to support user oriented Internet navigation by adopting keyword extraction and processing. This invention includes dynamic keyword extraction and processing from the web page that users visit, users' definition of keyword that is used instead of URL, user's keyword selection, and URL mapping system by E-mail ID. This invention manages technology that is related with E-mail addresses, domain addresses, keyword services, word listed on web pages, meta-tag information, URL string manipulation, indexing words, treating synonym, antonym and dictionary. Each element technologies are already developed and used in developer's situation. They are standardized laying stress on language and system of the developer or his/her country. Therefore, there remain difficulties for users who reside in non-English countries. This invention is an Internet technology in which users' situation, region, and language is reflected, to help them to use Internet navigation technologies more conveniently. It is a system and method for Internet navigation reconstructed as can be compatible with existing Internet element technology standard. It integrates these element technologies without separation them. A form that these Internet element technologies are involved each other in this invention is as following concretely. E-mail address can be a special form of keyword in case of using E-mail address in web browser's address bar. Also, if users want to define web site that they are visiting, a keyword abstraction and processing system can recommend suitable keyword for the web site. And users can store them as their own keyword. If users think a keyword that is more suitable and easier to remember than recommended one, users can edit and store this keyword definition by themselves. However it is not easy to define several web sites well known to users one by one. To support this, the system recommend some keyword groups and help the users to select the definitions of many site keyword together and to store the user's selection and using them in Internet navigation. As presented above, keyword address that users define, URL mapping by e-mail, keyword groups that users selection, and keyword abstraction follow a method that is reconstructed in users' situation for their convenience, as differ with existent method. Also, those offered method and system, which convert an access method that users reconstruct for their convenience to standard method that can access existent Internet resources. Moreover, to solve problems of service company-oriented alias definition and a method of service, this invention includes a method that help users to define their own name (from now on, let's call this “alias”) of sites that they use frequently and to use them. For this, this invention presents method and system about dynamic keyword extraction and processing. Existent web browser(S230) or tool bar support only connection or search for relevant site when users input string of keyword or URL etc. in an address bar.

But they do not use URL string that appears in address bar automatically when URL or web browser(S230) that users input is connected to web site in searching new keyword or connecting to web site. Existent methods use URL or keyword that users input only for an access to web site. They use URL that appears after site connection only to mark an address of relevant site and do not reprocess it. This invention provides methods to make users' navigation to relevant sites extracting keyword from URL that is displayed in address bar when URL, keyword or web browser(S230) that users input are connected to web site and processing and utilizing it. Also, this invention includes methods that use E-mail address as URL. Marking other's homepage in Internet address bar of users' web browser as other's e-mail address, it makes users able to access to other's homepage or blog. To use this function users have to install client software(J3) in users' terminal that can connect to Internet like their PC or PDA, etc. When E-mail address, not Internet address, appears in Internet address bar, installed client software(J3) asks conversion system server(J41) if Internet address that corresponds to it is defined. And if Internet address that is responded to E-mail address is defined, conversion system server(J41) transmits it to users' client software(J3). Client software(J3) that receives it runs users' web browser using last Internet address that corresponds to e-mail address which users input in Internet address bar.

And this invention includes methods that help users choose directly alias groups to be able to approach to URL for relevant web site using names, which are well known. In addition to keyword service by users' definition, it helps users choose directly group of names of a lot of general sites that user cannot define one by one. Group of names of sites differs according to users' usage of Internet, age and interest. Moreover, there can be sites that users do not want to access. Now, innumerable Korean addresses are registered, but keywords that ordinary people use mainly, for example, banking firm, portal site, public office, etc., are not many. This invention will increase convenience of using aliases or first language and users' possibility to be linked to site that they want to access. And it can reduce social side effect or side effect of alias that users do not want to use and activate use of users' first language. This invention gives choice to users using method of forwarding with newly defining Internet addresses used in dot notation method according to an existent international rules as alias. Forwarding service methods that use Internet address in other alias are already used. But, existent services make users connected to alias sites that the service company provides without considering users' age or interest, etc. Therefore, those can generate various side effects or injuries such as prior occupation by competing company, auction on general terms, and connecting celebrities' name to commercial sites, etc. Also, in a lot of occasions, those connect users to site not related to results that users want. It is desirable that users' first language is used in the Internet. But users' selection of aliases for Internet address or name servers is required because privileges, auction, prior occupation, injuries, and dispute can happen actually. Differ with existent another name service about Internet address, this invention can help users to choose alias that they want to use according to their conveniences, age, usage, region, and interests. Also, it can help users use name server about alias that users choose without depending on specific ISP company's name server for an item that they choose. And it can help users use aliases used often fast without flowing external name server by storing the aliases in their own terminal as alias DB.

### BACKGROUND ART

When general users use item as it is that general company which offer alias or forwarding service registers not verifying relation of alias with Internet site, harmfulness of relevant page, various disputes and side effect connected with damage or label can occur and there can be a lot of occasions that users are connected to site that they do not expect. Therefore, user-oriented alias is needed to increase connectivity to site that users want and to help users remember and write about sites that they often visit. This invention is to present method that can solve such problem to help users. Also provide users selection. Sorting Internet site by several categories and listing them is necessary. For example, there can be various classification method for public office, financial agency, organ of expression, school, academy, general business, electronic commerce, individual homepage, cultural science, social science, area information, art, and territory of performance. And more specified classification is needed according to user's age or sex, job, hobby, and interest. Also, classification of degree of people's usage or knowledge of sites listed above according to frequency usage of alias address. This invention provides method that can list categories classified to users and select those according to user's age, usage of Internet, sex, job, hobby, and interest. It also provides method that can store alias of Internet address that is included in a category that users choose to users' each terminal or external server that users designate and present method that connect utilizing items that user chose at the time of connection to web site when users input alias instead of Internet address and approach to the Internet. Also, method that can except a site which is chosen by users but is not a site that users want or help users define the site newly. Also, this invention got an idea that URL of relevant site that appears in address bar when string of URL or keyword or web browser(S230) that user input in web browser address bar(S210) to connect to web site are connected to relevant web site, has important information related to information that users want to find. Usually, domain name or URL are composed of words which is most related to contents that relevant site offers. Therefore, keyword can be extracted after URL input or registered in address bar is reprocessed. And related sites or search words that users will use can be prepared beforehand after extracted keyword is reprocessed in several forms.

This invention presents method of abstracting keyword from URL, reprocessing extracted keyword, and utilizing keyword for users' navigation of additional search. Also, this invention is about conversion system(J4) between e-mail address and Internet address which relates Internet address and e-mail address that corresponds Internet address and utilizes database in which Internet address and e-mail address are mapped each other. Specially, it includes method and system that offer function that helps users approach to Internet address of relevant e-mail owner's homepage with e-mail address that is used in case of sending and receiving messages with their acquaintances when they write homepage address without necessity to define and maintain special domain. So far, users' e-mail address and homepage address was expressed apart by different notation method, and users had to write Internet address for relevant homepage separately except their contact and e-mail address in lower column of e-mail message or in business card. Also, when users use homepage or blog utilizing portal site, Internet address appointment method is different from each other according to service company. And method that help users to access Internet address using their e-mail ID did not exist. Generally, e-mail ID can be expressed shortly and it is permanent relatively. On the other hand, Internet address of homepage of users or their blog changes more, and has less regularity. It needs time and expense for users to create homepage themselves and manage it. Furthermore, because homepage address is longer and more complicated than e-mail address usually, accessing homepage of others with memorizing its address is not easy. In this invention, URL address system that utilizes e-mail address, without necessity to register domain address separately, helps users approach web site using E-mail address as domain address.

### DISCLOSURE

### Technical Problem

When user navigates in the Internet, they must input English URL. However, for user who is unaccustomed on the Internet or user whose first language is not English, this is not easy to do. Also, it needs time to confirm that site that users visit is the one they want to find. And even if users use keyword service instead of URL address, it is possible that web site in keyword mapping is not the one users expect. Also, when users make their homepage, mini homepage or blog, they have to be newly assigned URL. And when users visit homepage or blog of their acquaintances, they have to remember URL of those or inquire those. So to solve these problems and support user oriented Internet navigation, this invention presents method of defining keyword address service for users, keyword abstracting and processing, users' selection of keyword groups, and method of using e-mail address as URL. Also, this invention got an idea that URL of relevant site that appears in address bar when string of URL or keyword or web browser(S230) that user input in web browser address bar(S210) to connect to web site are connected to relevant web site, has important information related to information that users want to find. Usually, domain name or URL are composed of words which is most related to contents that relevant site offers. Therefore, keyword can be extracted after URL input or registered in address bar is reprocessed. And related sites or search words that users will use can be prepared beforehand after extracted keyword is reprocessed in several forms. This invention presents method of abstracting keyword from URL, reprocessing extracted keyword, and utilizing keyword for users' navigation of additional search. Also, this invention presents method to help users define alias of sites that they mainly use to solve problem of the existent service company-oriented alias definition and way of service. In order to provide users selection, sorting Internet site by several categories and listing them is necessary. For example, there can be various classification method for public office, financial agency, organ of expression, school, academy, general business, electronic commerce, individual homepage, cultural science, social science, area information, art, and territory of performance. And more specified classification is needed according to user's age or sex, job, hobby, and interest. Also, classification of degree of people's usage or knowledge of sites listed above according to frequency usage of alias address. This invention provides method that can list categories classified to users and select those according to user's age, usage of Internet, sex, job, hobby, and interest. It also provides method that can store alias of Internet address that is included in a category that users choose to users' each terminal or external server that users designate and present method that connect utilizing items that user chose at the time of connection to web site when users input alias instead of Internet address and approach to the Internet.

This invention includes methods that use E-mail address as Internet address to solver problems above. Marking other's homepage in Internet address bar of users' web browser as other's e-mail address, it makes users able to access to other's homepage or blog. To use this function users have to install client software(J3) in users' terminal that can connect to Internet like their PC or PDA, etc. When E-mail address, not Internet address, appears in Internet address bar, installed client software(J3) asks conversion system server(J41) if Internet address that corresponds to it is defined. And if Internet address that is responded to E-mail address is defined, conversion system server(J41) transmits it to users' client software(J3). Client software(J3) that receives it runs users' web browser using last Internet address that corresponds to e-mail address which users input in Internet address bar.

### Technical Solution

This invention got an idea that string is chosen among names that reflects character of relevant web site best or words related to it most. URL have a form of 4 linked domains and the form is as following:
Top-level domain of URL has information of character(company, government, military, school, country, region etc.) of domain.
The second level (2nd level) domain has information of character(group, company, net, school, etc.).
The third level (3rd level) domain has name of agency, keyword of site.
The fourth level (4th level) domain has information about name of server.

| | |
|---|---|
| URL of Korean Parliament: | www.assembly.go.kr |
| 3rd level domain: | assembly |
| 2nd level domain: | go |
| Top level domain: | kr |

In this case, ‘Assembly’, the third level domain, is extracted in keyword. And the second level domain ‘Go’ displays category of web site for government agency. Also, the highest level domain ‘kr’ expresses country of Republic of Korea.

Extracted keyword is assembly and there is ‘National Assembly’ in word that translates it and there are synonyms ‘Parliament’, and ‘Congress’. There are related words such as ‘National Assembly stenographic record’, ‘National Assembly schedule’, ‘Member of the National Assembly’, ‘General election’, and ‘Legislature’ search result of related site by search engine can be web site name and URL such as ‘National Assembly Library’, ‘National Assembly's history’, ‘Generation after generation, Speaker of the National Assembly's introduction’, and ‘National Assembly budget process monitor’ etc. Also, in case of www.yahoo.com, its highest level domain ‘com’ displays character of domain, and it does not have the second level domain because it is not country domain. And its third level domain is ‘Yahoo’. Therefore, its keyword can be extracted as the third level domain ‘Yahoo’. Also, when using keyword service, users may input keyword in address bar from the first. In this case, keyword is the keyword that users input, and their keyword is registered in keyword indication window(S220). Despite using method presenter above, there is an occasion that keyword is not extracted properly from URL. That is, there can be occasions that URL is made of alternative word or roundabout word way, string that is hard to recognize for machine, because of preoccupation of good words or of purpose to shorten URL or domain name as possible. To supplement this, 2 methods can be used.

First, in case of abbreviated word or shortened word, there is method that supplements items that is hard for users to search in dictionary DB by storing abbreviated word and keyword that can be expected from shortened string apart from dictionary DB, when relevant string comes,

There is method that extract keyword from name and comment for relevant URL displayed from search engine delivering URL registered or input in web browser address bar(S210) to specific search engine. Using this method, we can improve accuracy of keyword abstraction from sites that use domain name or URL consisted of string that is unrelated to character of web site. For extending abbreviated word or shortened word to keyword, definition of those words should be prepared by database inside system in order to embody 2 methods above. And when keyword is not extracted using URL, programming module that search information of relevant site sending search engine whole URL is needed.

System that this invention presents for this keyword extracting and processing and extending to related word and related site list is composed of following modules. (i) Programming module to receive string that is input or is registered in address bar. It inputs string or marks web site URL in web browser address bar(S210) (S10). (ii) Programming module that divide input string and extracts keyword. It extracts keyword from the third level domain.(S20) (iii) Programming module that processes extracted keyword. It searches for synonym, translated word, related word of keyword(S30) (iv) Programming module that searched for database to process keyword and word related to keyword. It searches them in database or external specific server and offers them. (S40) (v) User interface programming module that defines the way users process and mark keyword. It provides selection of whether users will only mark keyword or process keyword in certain form and mark it.(S50) (vi) Programming module that searches for string or connects string. It runs web browser(S230) by method that users want. And so on, the system is composed of total 6 modules.(S60)

Each practice module can change its position according to embodiment method of program. Users can arrange whole module and database that is mentioned above in their terminal, arrange whole of them in external specific server, or arrange some parts of them in users' terminal and arrange remainder in external servers.

Actions of each module are processed by the order of module, mentioned above. But, users can execute, at all stages of system of this invention, (v) user interface programming module that defines method that they mark and process keyword(S50). When there is no definition of method by users, it is executed by method that system predefines.

301 and (iv) programming module that search related word using database to process keyword and keyword(S40) means database and programming module that searches database. Database situated to user terminal or database of all external specific servers can become database. After keyword is extracted from URL, programming module that search related word about keyword searches word or site connected with keyword that is extracted using search engine or specific database. And it prepares to mark in tool bar or address of users. Extracted keyword and related words can be registered for keyword indication window(S220) or tool bar or pop-up windows. For more perfection, it is desirable to make keyword indication window(S220) beside address bar and list extracted keyword and related words inside of the keyword indication window.(S220) It is more desirable that a related word or web site is registered just after being searched because search requires time. When a URL is registered in address bar of web browser by web site visit, it is accepted as string by program mentioned in an article, (i) Programming module to receive string that is input or registered in address bar’ (S10), by the same way as users' input. Abstraction and processing keyword, search of connection word or web site of keyword and indication of result of process are repeated continuously by users' navigation. The (vi) programming module that searches string or connecting the web site(S60) mentioned above reduces formality and time of users' visit to search engine in their navigation. By using the system and method that this invention described, users can open web site just in time using relevant keyword, select result of process that is registered on keyword indication window(S220) or tool bar, pop-up windows or search. Also, this invention helps users to define sites that they often use and approach as alias that is easy for users remember and input and to approach relevant sites. For this there are three steps.
Step 1: Users define Internet addressed that they often use as alias that is easy to remember.
Step 2: Users store contents that they defined in their Internet terminal(UT) or external server in DB form.
Step 3: Users can correct, add, or delete their definition.

At step 1, users define alias of sites that they often approach as following. Users write Internet address by dot name method and map alias that they define to it. Users' definition can make several definition for one site. Detailed composition of this invention can be explained using affixed drawing as following. Chart 5 displays whole composition of invention and action. It is a example following basic thinking of this invention. In users' terminal, there are web browser for access Internet or Internet tool(WB), users' alias DB(UD that stores their definition of web site), and an alias processing program(UC) that search and substitutes input string between web browser (WB) and users' alias DB(UD). For simple expression, let's express all Internet tools that need URL or IP address as WB, and write Internet tool or web browser as web browser only. A alias processing program(UC) moves with web browser and it waits string that users input in web browser address bar. In case input string is URL, a alias processing program(UC) does not treat it, and in case it is not URL a alias processing program(UC) consider it as a alias and search for URL that responds to alias from alias DB and DB of name server in turn. A alias processing program (UC) substitutes URL of search result for input string and makes it return to address bar of web browser. Also, a alias processing program(UC) has processing part for users' definition of alias. If users try to define alias of web site that they are visiting, An alias processing program(UC) offers interface to them and supports addition, alteration or cancellation of a alias of web site of users. When string input by users from web browser or Internet tool has its own alias and URL, IP address, or domain name which corresponds to the alias, for example, in case it is composed of Hyper Text, there is no need to search or replace input string. It is enough to move web browser of Internet tool(WB) to the last address linked to provided hyper text. In drawing 6, this process is displayed by drawing of sequence. Routine that receives, changes, or deletes input definition of alias is displayed in st30, st40.

And the routine that takes input string from web browser or Internet tool(WB), searches users' alias DB(UD) and external name server DB, substitutes searched URL, IP address or domain name for them, returns this to web browser or Internet tool(WB), and moves web browser or Internet tool(WB) is displayed in st60, st70, st80, st90, st100, st110, st120, st130, st140. In case users want to use definition of alias they did not define, external name server is assigned. A alias processing program can search input string additionally in case it is not in users' alias DB(UD). Since searching alias and replacing input string by using external name server is technology noticed before this intervention, this intervention does not treat specific explanation for it. But in case, users designate an external name server, noticed technology can be combined additionally. In drawing 7, an example of a form of users' alias DB(UD) located in users' terminal(UT) in composition picture of drawing 5. And in drawing 9, an example of a form of users' alias DB(UD) located in an external server in composition picture of drawing 5 is displayed. Drawing 7 and 8 are different from each other only in a point that users' alias DB(UD) is in users' terminal or in an external server. An advantage of location in users' terminal is that access speed is higher than a case of using external server because users' terminal just gets URL, IP address or domain name for alias and runs web browser or Internet tool(WB). But since users' terminal needs store space and alias processing program, composition of drawing 8 is more rational in case of cellular phone or PDA, which is restricted in using terminal. In composition of drawing 9, users' alias DB(UD) is located in users' terminal and users can use alias DB of name server for alias that is not in users' alias DB(UD) by designating name server. In composition of drawing 10, users' alias DB(UD) is located in external server and users can use alias DB of name server for alias that is not in users' alias DB(UD). Composition of drawing 9 is made of composition of drawing 7 and name server. And composition of drawing 10 is made of composition of drawing 8 and name server. External server can do a role of storing users' alias DB(UD) and of name server at the same time. And users can use external name server while they use external server. Composition is fundamentally specified by the point that UD is located in users' terminal or out of it and users designate name server for searching and using second alias or not. An example like drawing 11 can appear after basic thought of this intervention is applied to web browser by entire composition of drawing 5 and whole flow of process of drawing 6. After UC hooks users' alias input in web browser, searches it in UD, replaces searched string for it, and returns a result to web browser, web browser makes users to approach web site they want using users' alias. When web browser runs, UC runs with it, waits for string input by users, and process alias for the string. When users call by interface screen provided by UC to add, change, delete definition of alias, UC present screen that can receive, change and delete users' definition of alias. This users interface screen is dependent on embodiment of program. And an interface screen in affixed picture is an example of execution of this intervention. Also, this invention helps users to define sites that they often use and approach as alias that is easy for users remember and input and to approach relevant sites. For this there are three steps. Step 1: Users define Internet addressed that they often use as alias that is easy to remember. Step 2: Users store contents that they defined in their Internet terminal(UT) or external server in DB form. Step 3: Users can correct, add, or delete their definition. At step 1, users define alias of sites that they often approach as following. Users write Internet address by dot name method and map alias that they define to it. Users' definition may yield multi-definition for one site.

| URL | User's Alias or Keyword for the URL |
|---|---|
| http://www.kipo.go.kr | patent |
| http://www.kipo.go.kr | 1 |
| http://www.metanav.com | m |
| http://www.metanav.co.kr | [symbol] |
| http://www.yahoo.com | y |
| http://www.kbstar.co.kr | kb |

Users can define one site with several aliases like this. And the aliases can be made by combination of all letters and numbers that users can input. Especially when a user accesses Internet by a PDA or a cellular phone, an approach by defining abbreviated name that they can input easily can be an effective making method for terminal that is not easy for users to input. And users can define one site as several aliases. When users visit specific web site using web browser or Internet tool(WB) and want to define alias like this, they open tool or editor to define alias, define web site they visit as alias that is easy to use, input alias in tool or editor to define alias, and define alias. And users can input definition of alias by editor for UD without visiting relevant site. Definition of alias using editor is desirable when users know URL, domain name, or IP address of relevant site. In step 2, users' alias list defined in step 1 is stored in storing space in users' terminal or external server. For more perfection, it is desirable to store alias list in users' terminal as DB. But when character of users' terminal makes it hard to store directly or users want to use UD typed in desktop in their cellular phone or PDA, they can store UD in external server and use it. In step 2, step that adds and stores one of users' alias, domain name of specific web site that corresponds to the alias, IP address, or URL in alias DB as alias record includes step that a alias processing program connects users' alias DB, and step to store with one of input alias and domain name of web site users visit, IP address, or URL. Step 3 is about adding and erasing users definition. And when Internet address or content of relevant site is changed or users want to change alias they use into another one, interface that can change them in UD. This interface includes step that users' request clicks button or runs program of editor that is marked by hyper text, step to output users alias DB stored in UD on screen, step that users change or delete alias record of specific item in users' alias DB, and step reflect and store contents that is deleted into users' alias DB. Using editor, users can delete and delete existent alias and add new definition of alias. As an interface for step 1 and 3, method of adding menu for UD update to mouse click menu and getting address of explanation or site that is a result of search engine by mouse click and editing it, or using separate editor. In addition to works above, a program that can process string that is input in Internet address bar by users are needed. In this intervention, this program is called UC. UC is installed in users' terminal and users' alias DB that UC searched is located in users' terminal or external server. UC receives string input by users and starts to search in order of UD and name server DB in case the string is considered as alias. UC searches for URL address that corresponds to input alias and substitutes searched URL for input string and returns it. UC judges if input string in Internet address bar by users has a form of dot name, considers the input string as alias in case it does not have a form of dot name, searches for domain name that corresponds to relevant alias in UD defined by users, and input the domain name in Internet address bar. Marking by dot name doe not need replacement by UC. And since UC only replaces string, it does not affect network composition of terminal and makes users to approach site they want by alias. Replacement of UC is as followings. When string that users input in Internet address bar is keyword, UC searches for URL that corresponds to relevant URL in DB that users defined. In case the URL exists, UC changes the keyword to relevant URL and sends the URL to web browser or Internet tool. In case the URL does not exist, UC changes the keyword to URL that corresponds to keyword that came as input string from name server that users designate and sends the URL to web browser or Internet tool. Client program hooks string input by users. And it considers the string as keyword in case the string does not have a dot and starts to search for URL that corresponds to relevant keyword in DB. Judging by existence of dot is an example of method of telling URL and keyword apart. And it is not included in articles of request of this intervention. Recently, since [symbol] .com that uses Korean code is used as one of standard method of marking domain name, string including Korean code may not be keyword. Dot inclusion is presented as just one example of judging keyword. Searching process searches for relevant string in keyword DB users defined first, in case the relevant string exists, changes it into URL that corresponds to it, and returns the URL to address bar of Internet tool. If the relevant string is not in DB users defined, the searching process searches for it in name server DB users designated, changes it to URL that corresponds to it and returns the URL to address bar of web browser. That is, UC only does a role considering string as keyword in case dot is not in input string of users, starting to search in keyword DB of users and name server, changing the keyword to URL that corresponds to it, and returning the URL to Internet tool. Web browser that receives URL, without change of way of its running, processes input URL as it and accesses to Internet. If input string that web browser or Internet tool receives from users has a form of Hyper Text and definition of link, there is no need to search for alias of UC, URL that corresponds to alias, domain name or IP address. A link of input alias has to be returned to web browser or Internet tool and web browser or Internet tool should run the link. An advantage of restriction of UC that only replaces processing input string in address bar. UC, located in users' terminal, waits and processes in case input string in address bar is alias is limited to replacement. To Internet tool, string that is input at last after hooking process between users and tool is URL in a standard method, changing form of Internet tool is not necessary. Maintaining standard on Internet naming scheme, the users may access Internet by using definition of alias that preferred characters and languages of each users. The hooking technology, used in Internet programming is adopted for replacement mentioned above. It is a well-known technology generally used in Internet programming. If a user doesn't want to use external name server or URL that responds to relevant string is not in external name sever, search can start after input string is sent to search engine or output message that relevant string is not in keyword definition can be displayed. This example is about difference according to method of embodiment of program. This intervention does not treat method of processing keyword. In many cases, users' defining and using their alias is possible only when site that can be accessed by alias is limited to the site that users can test and use safely. Therefore this has feasibility of embodiment and usage. Using forwarding service or alias service which are prior to this intervention, finance agency, public office, and search and portal site are usually approached, and adult site or harmful site which are not related to alias are approached in many cases. Method of approach with users' real alias is convenient and searching for site that is registered by service company and is not tested and approaching it is usual. Since UD is limited to users only, it does not affect others and change composition of network. And this invention raises keyword connectivity to destination web sites that users anticipated and make users to utilize convenience of alias for local languages and characters, regardless of their regions or countries. This invention has 6 steps as followings:
Step 1: Classifying Internet sites mentioned above and collecting and making list of their alias.
Step 2: Classifying the list into age, field, commerce, public agency, company, dividing it according to reputation or relation and loading it in alias DB of name server to fit for character of users.
Step 3: Displaying classified list to users, presenting field of service of name server of alias, making users to choose name server for alias according to their age, interest, usage.
Step 4: Storing information of name server and main alias users chose in their terminal as DB.
Step 5: When users input alias in Internet address bar, searching for actual Internet address that corresponds to the alias in alias DB of users' terminal or in DB of name server users choose.
Step 6: When alias input by users are not in name server(A1) DB, presenting another related site.
Step 7: updating users' alias DB(UD1) whenever users' need or change of information about relevant field of users' alias DB(UID1) happen.

In step 3, alias DB(UD1) for each user is made in users' terminal using alias group that users chose. To make users to use this as their alias of Internet address, alias they chose should be stored as a form of DB in users' terminal or external server. These two methods all need a software that is located in users' terminal, searches for Internet address that corresponds to input alias by users, runs web browser using it. In this invention, we call this software “client”, a thing that searches for Internet address in alias DB for alias request of client(UC1) “server”, and alias users chose “alias DB”. alias DB can be stored variously by users' selection and be presenter to them. A standard that collects, makes, and classifies alias DB should reflect recommendation of public or related group and add relation, existence of recommendation, age limit, commerce, division of category to DB field. In users' terminal, there is a routine that processes input string by users. When the routine consider the input string as alias, the routine sends it to client(UC1). And client searches for and takes an actual Internet address from users' alias DB in which site users chose is defined, which is stored in users' terminal or server they designated. And it sends the Internet address to string process routine. At the moment that string users input in Internet address bar is considered as alias, the string process routine sends it to client(UC1), changes it to an actual Internet address that client searches for in UD1 and sends and runs web browser. In using alias, string process routine located in users' terminal is included in function of client(UC). It takes input string by users. If the input string is usual Internet address of dot name marking method, client(UC1) does not process it and sends the string to web browser. But if the input string is not dot name, client starts to search by search engine or search for alias DB according to users' definition of process for this. When client(UC1) processes string by alias, the client searches for alias DB defined by users in terminal and changes it to Internet address that corresponds to it. If the Internet address is not in users' alias DB, the client searches for an actual Internet address for alias using external alias server(AG) that users designated and runs web browser. Value searched by AG is added to UD1. If there are several definitions for one alias, the client outputs them to users and gives them selection and only one definition of site chosen by users are added to UD1 in users' terminal. If relevant alias is not in AG that users designated, the client presents site about related alias in AG and simple explanation and helps users' selection. For alias DB, there are a method to store it in users' terminal and a method to store in A1. Internet address basically is approached by Internet address naming scheme. Addresses approached by alias are not so many and mainly they are sites of finance agency or portal sites. Therefore, even though UD1 stored in users' terminal has information of small capacity, it can make users to connect to Internet with alias. Therefore, method of storing alias used frequently in users' terminal and using it has reality of embodiment. Fundamental thought of this invention considers alias as forwarding service method to define alias by cover word instead of dot name marking. Cover has bigger effects on Internet space that cover does in real space.

It is main object of the Trademarks act, Injustice competition prevention law, Internet address administration law of which legislation is noticed in advance. Therefore, selection should be given to users to prevent side effect that can occur in case service company define alias by auction or pre-registration. And if users consider their age or Internet usage and put definition of alias they often use in their terminal as a form of UD1, connectivity to site they expect can be higher and speed of connectivity can be higher. Storing alias and approaching do not require high technology and they gives users selection and are different from service company-oriented connection. Thus, thought of this invention should be preserved from similar methods which pass articles of request of this invention. And this invention is composed of followings. Mapping database(J42) defines users' e-mail address and Internet address that corresponds to it. Client software(J3) judge if address input in Internet address bar in users' terminal is e-mail address, sends input e-mail address to conversion system, asks an actual Internet address that corresponds to it, and runs web browser using answered Internet address. Conversion system(J4) is composed of mapping database(J42) and conversion system sever(J41) and is connected to users' terminal through Internet. Users' client software(J3) judges if item input in address bar is e-mail address or Internet address and sends e-mail address to J4. And it runs web browser using Internet address returned from J4. Client software(J3) has several methods to judge contents input in address bar of web browser. But this invention considers string that includes “@” letter as e-mail address. Client software(J3) receives string that includes “@” and asks conversion system and runs web browser using an actual Internet address from conversion system. This invention process only e-mail address for protocol of “http” or “ftp” that did not exist before. Conversion system or client software(J3) do not process string that is marked as “mailto” and is provided before and sends it to web browser for processing it. Composition of mapping database(J42) that defines mapping between users' e-mail address and Internet address is like this.

| E-mail address(J6) | Internet Address(J7)/URL |
|---|---|
| junewhi@hotmail.com | http://www.hihome.co.kr/~junewhi |
| hyunhchoi@yahoo.com | http://blog.yahoo.com/liyunhchoi |
| . . . | |

Conversion system(J4) that has mapping database(J42) defined above gives an answer to a question of users' client software(J3) when following string comes in users' web browser address bar.

| Input String | Replacement by Conversion System |
|---|---|
| http://junewhi@hotmail.com | http://www.hihome.co.kr/~junewhi |
| junewhi@hotmail.com | http://www.hihome.co.kr/~junewhi |
| ftp://junewhi@hotmail.com | ftp://www.hihome.co.kr/~junewhi |
| http://hyunhchoi@naver.com | http://blog.naver.com/hyunhchoi.do |
| . . . | |

If string input by users' address bar includes “@”, J3 sends it to J4 and asks a question. Mapping system searches for J42 for the question and gives upright string as an answer. J3 runs users' web browser using answered string from J4 and screen in which mapped Internet address is input appears for inputting e-mail address of web browser and screen of relevant Internet address is output. Using this mapping database(J42) users can approach Internet site and send e-mail address with e-mail address. And discomfort to remember and mark Internet address. J42 is stored by J4 between e-mail address and that this invention defines. J4 maintains stored database and answers Internet address that is mapped in case a question comes through the Internet. And it updates J42 when users define Internet address of homepage that corresponds to their e-mail address. When users want to use service mentioned above through the Internet in their terminal, users' terminal needs J3 that sends e-mail address input in address bar of web browser to J4 and asks if e-mail address that corresponds to it. And when users want to define or change an actual Internet address for their e-mail address in J42 of J4, J3 offers user interface for mapping database of conversion system. This invention defines users' agent that does this role as J3. And there is a method that J41 sends an e-mail to ask for check before mapping DB update and updates in case last mail for check is well received. A functions of J4 is as followings:

Step 1: defining e-mail address and Internet address and collection them.

Step 2: updating defined J42, adding and erasing it

Step 3: returning an actual corresponded Internet address for a question that includes e-mail address from J3 using J42.

[Advantageous Effects]

This invention decreases discomfort that users input keyword or URL in web browser address bar to approach web site and input URL or search for related site from the first whenever they do not want accessed site or have to move to another related site. It processes keyword and related keyword from the site users visit once and presents them to users. And it can search for web site that has high possibility of being visited by users and prepare related words in users' terminal Also it can decrease time and efforts to input URL, to search repeatedly, or to navigate. There are sites that companies mainly use for their business, sites to cut off for security of company or character of works, sites that general users expect to approach according to their age or Internet usage and sites that they do not want to approach. Using alias instead of dot name in marking Internet address is more convenient for beginning Internet user or young students. Users' definition of sites that they visit many times can prevent side effect that is caused by one-sided alias registration of service company and decrease problems which are related to pre-occupation or violation of rights related to cover on Internet. And users can increase connectivity to sites they want and speed of connection to the sites can be increased because connection does not pass name server by using UD of UT.

There are sites that companies mainly use for their business, sites to cut off for security of company or character of works, sites that general users expect to approach according to their age or Internet usage and sites that they do not want to approach. Using alias instead of dot name in marking Internet address is more convenient for beginning Internet user or young students. And users can increase connectivity to sites they want and speed of connection to the sites can be increased because connection does not pass name server by using UD of UT. In case an actual Internet address is defined in other's e-mail address, users can access to other's homepage without memorizing address of it by only inputting e-mail address with conversion system and client software. Especially effort and expense to get domain for individual homepage and maintain it can be diminished. If they write e-mail address in message or name card, there is no need to mark users' homepage address because e-mail address is generalized and Internet address can be marked by e-mail address. If a blog or an individual homepage address is used for access by marking them as they are equal to e-mail address, individual homepage and blog become easy to use, exchanging information becomes convenient and simple, and violation of rights by similar domain or pre-occupation of domain name can be prevented.

### DESCRIPTION OF DRAWINGS

FIG. 1 shows each module of Keyword extraction.

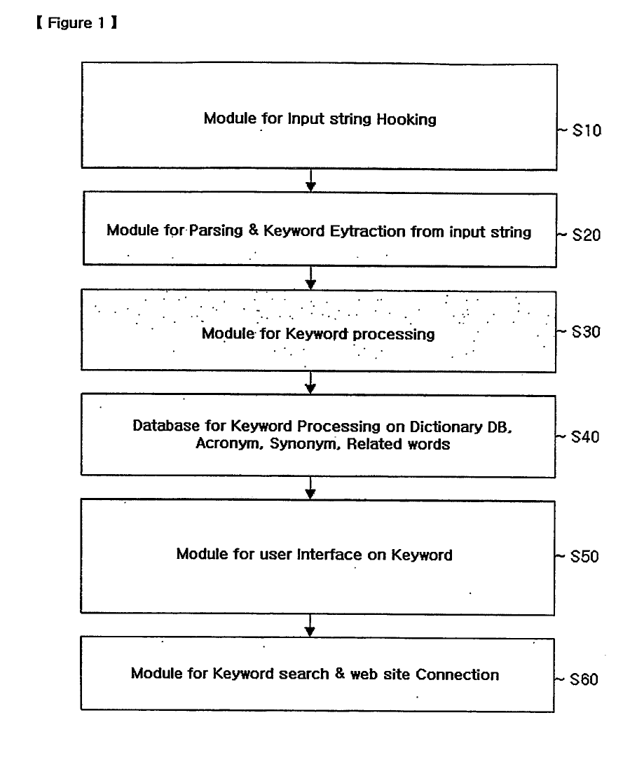

FIG. 2 shows an example of executed window of Keyword extraction.

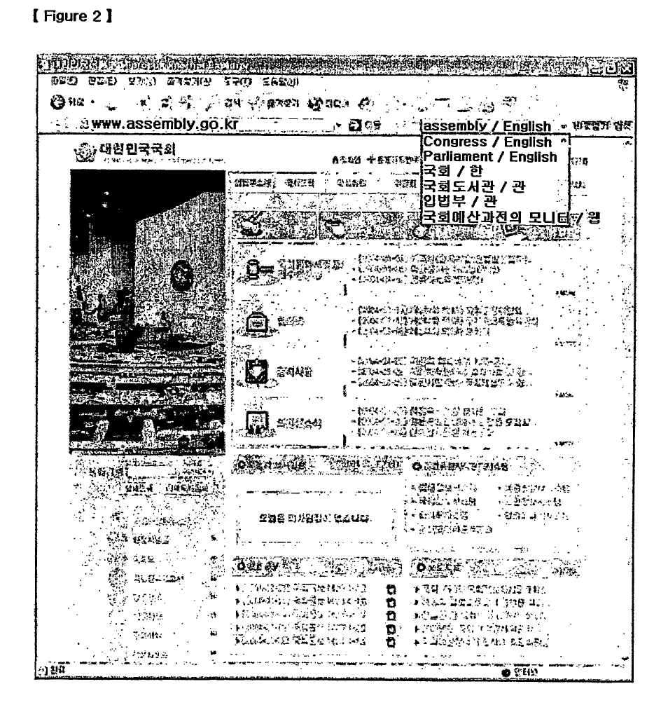

FIG. 3 shows a flow chart on Keyword Extraction and Processing.

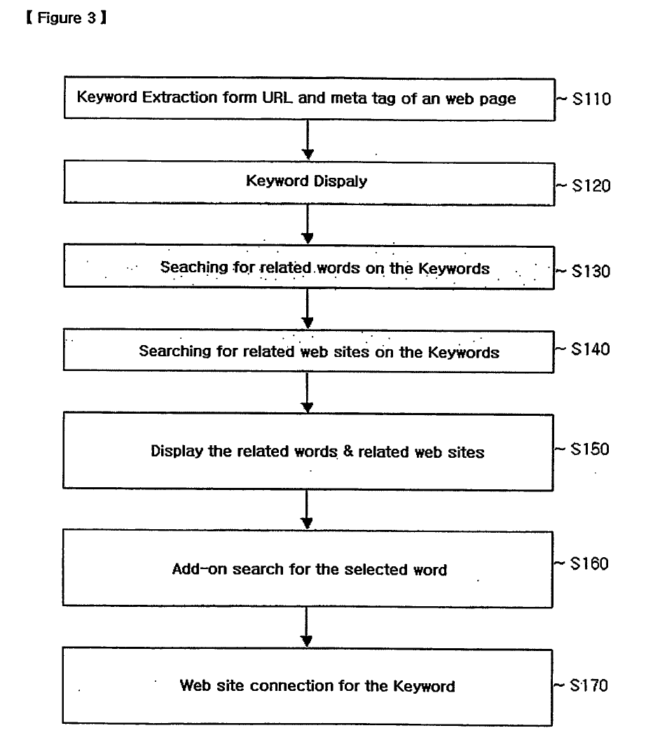

FIG. 4 is a Diagram for Keyword Extraction & Processing System.

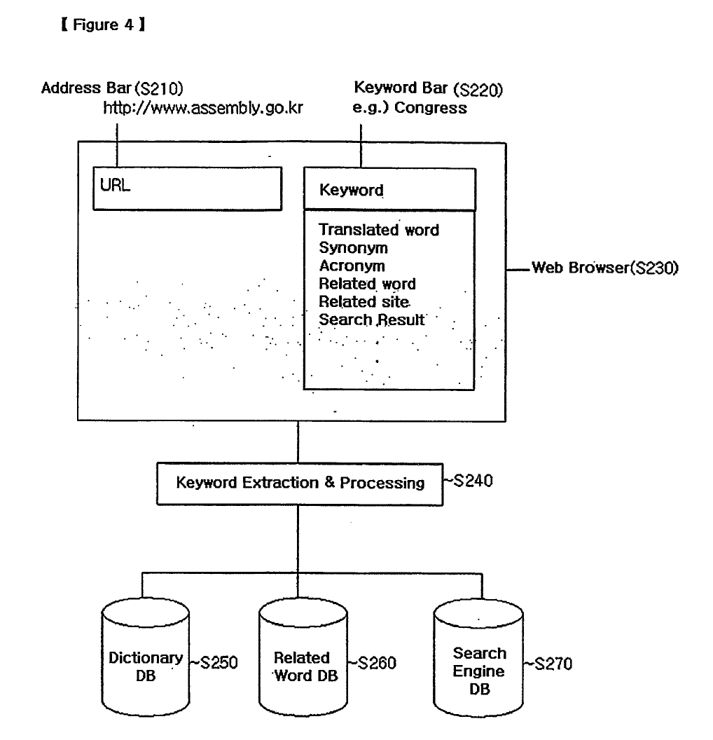

S10, S20, S30, S40, S50, S60: Each module for Keyword Extraction and Processing

FIG. 5 shows user oriented Keyword Definition.

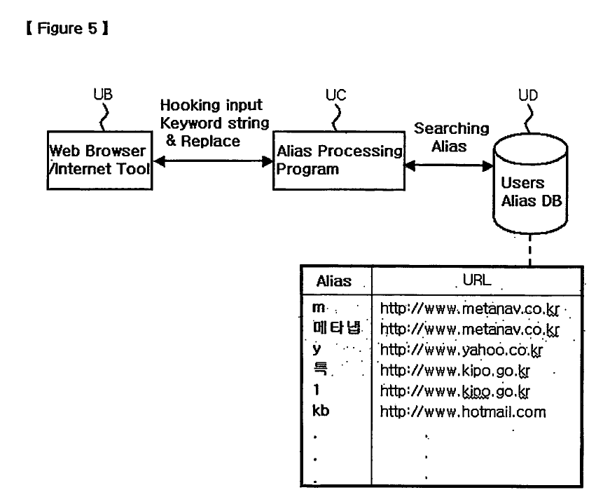

FIG. 6 shows a flow chart on user oriented Keyword Processing.

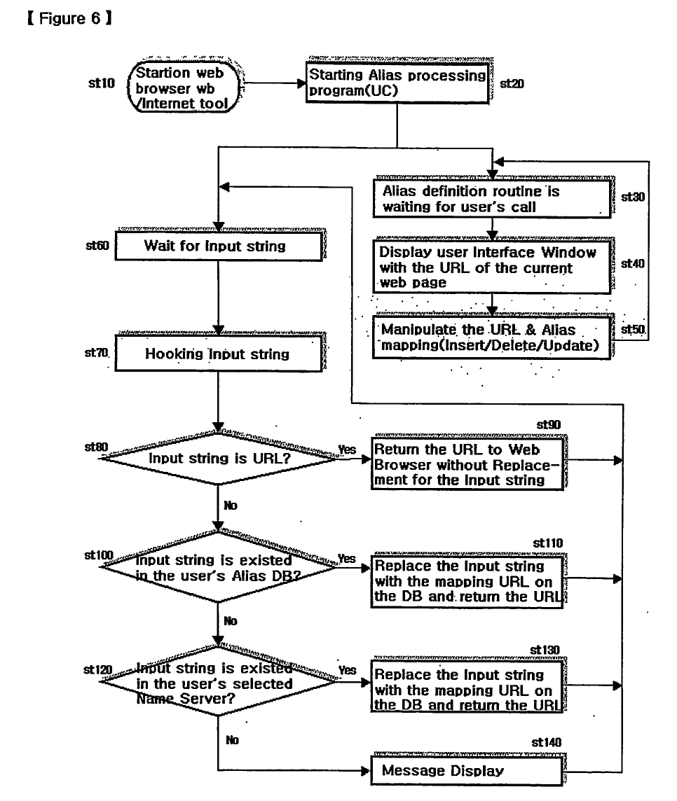

FIG. 7 shows a diagram for user side Alias DB on users Terminal.

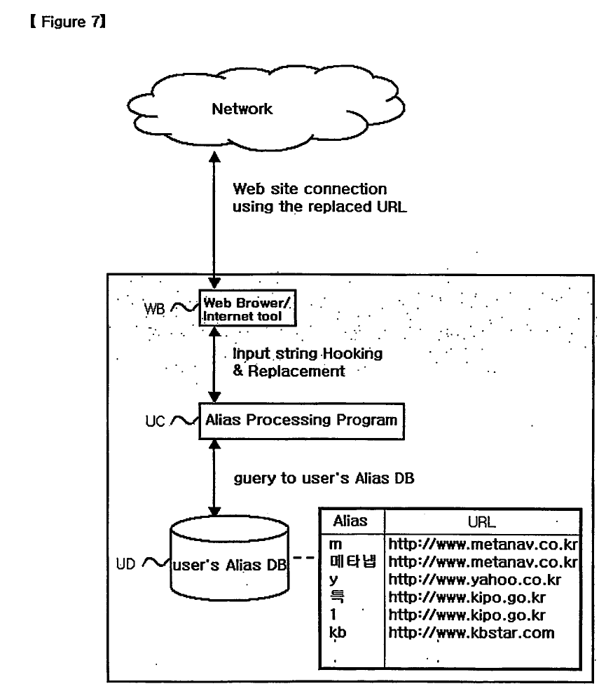

FIG. 8 is a diagram which shows connection between User Terminal and External Name Server and the user's Alias DB resides on the external name server.

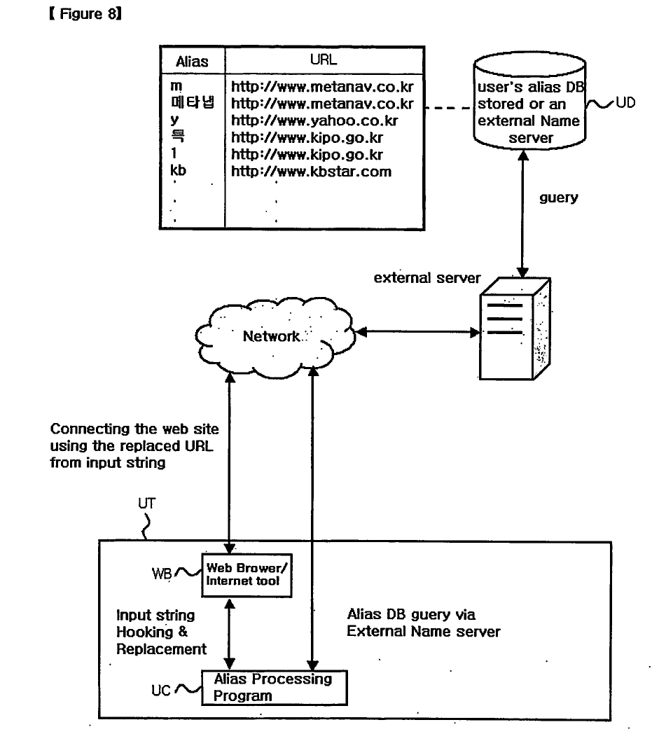

FIG. 9 shows connection between User Terminal and External Name Server, for which the user's Alias DB resides on the user's terminal.

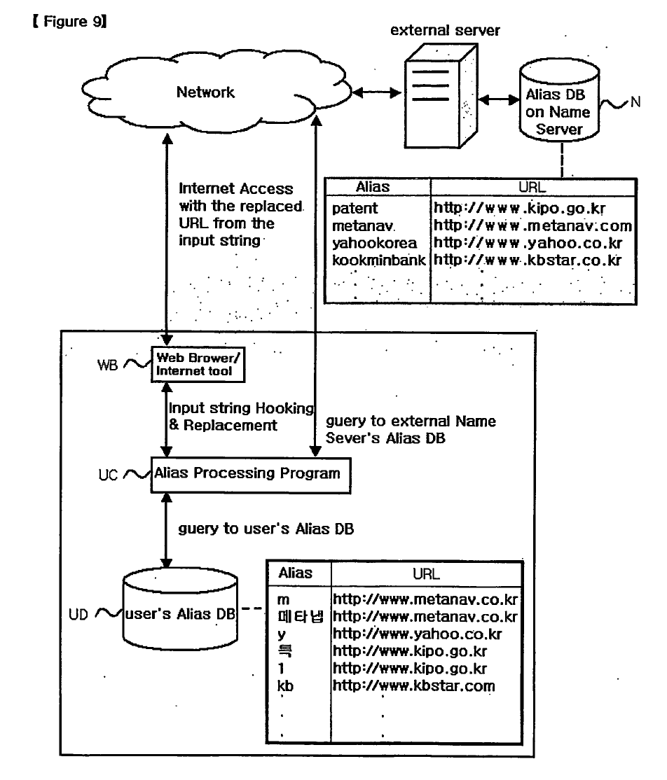

FIG. 10 shows connection between User Terminal and External Name Server, for which the user's Alias DB resides on the external name server.

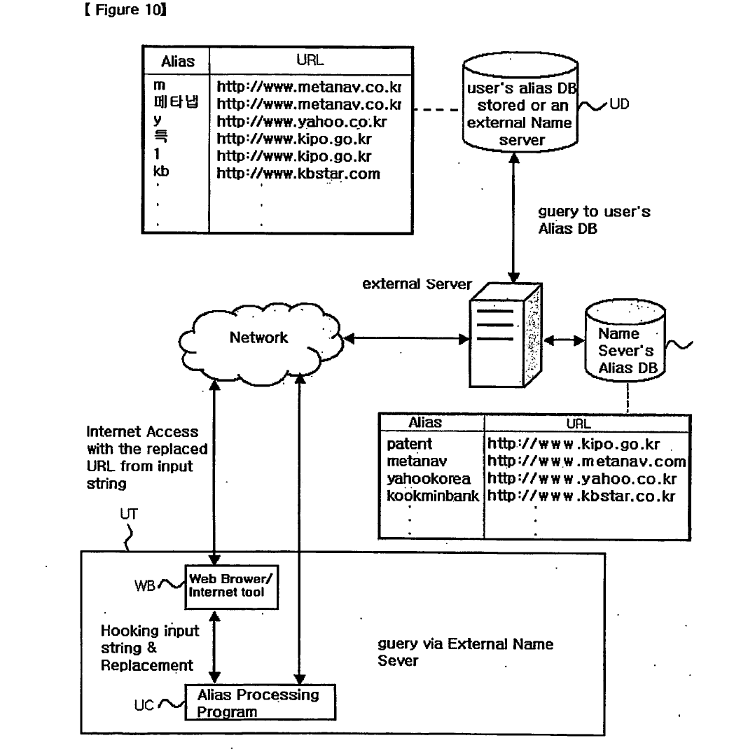

FIG. 11 shows an example of an execution mode.

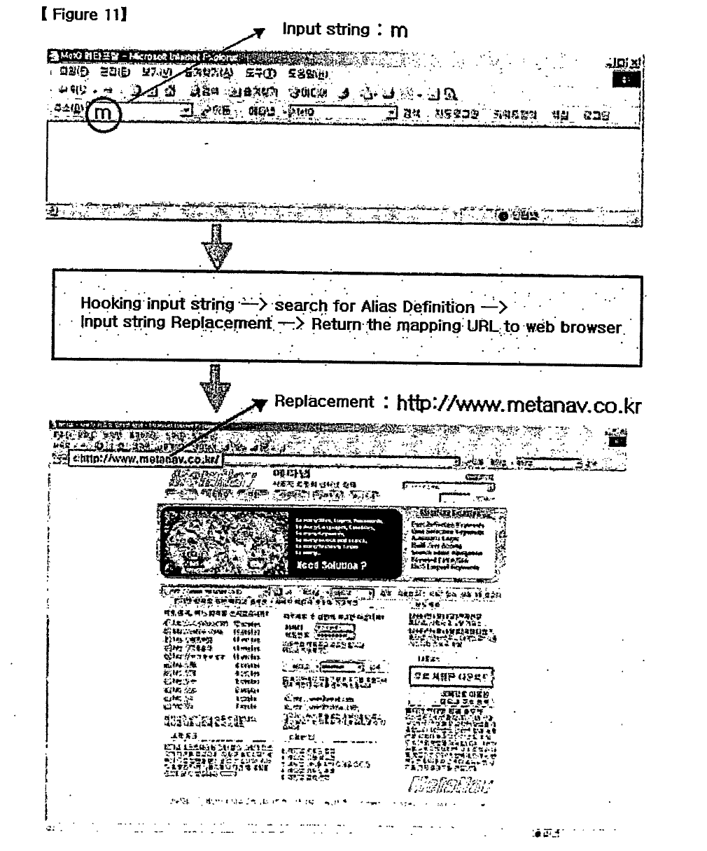

FIG. 12 shows user's Keyword Definition procedure.

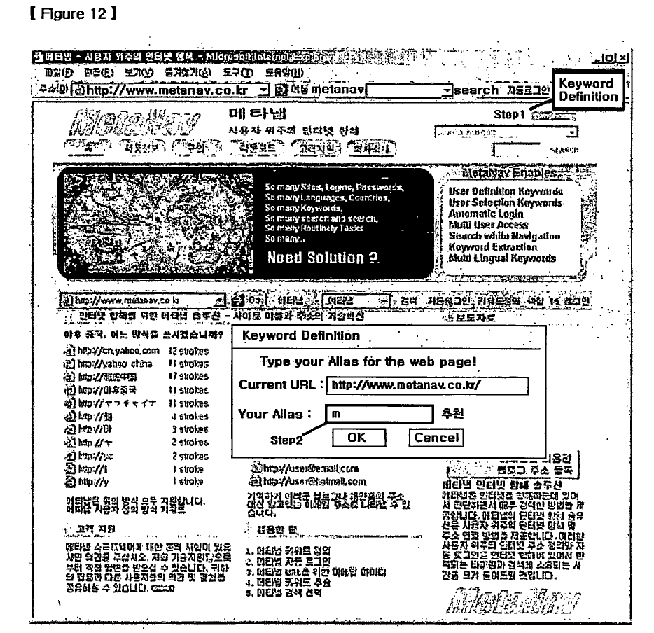

FIG. 13 shows user's manipulation of Alias DB, using Alias editor.

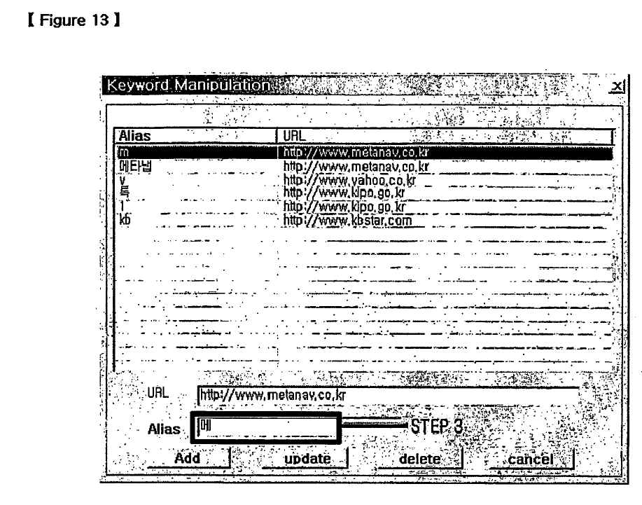

FIG. 14 shows an example of user oriented keyword execution for which the user's Alias DB resides on an external name server.

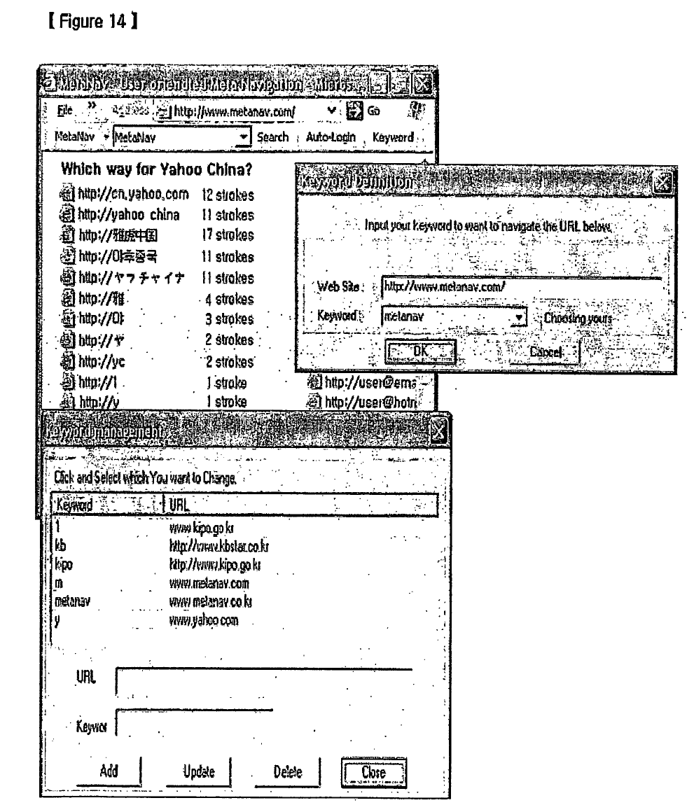

FIG. 15 shows each processing flow on user selection keyword.

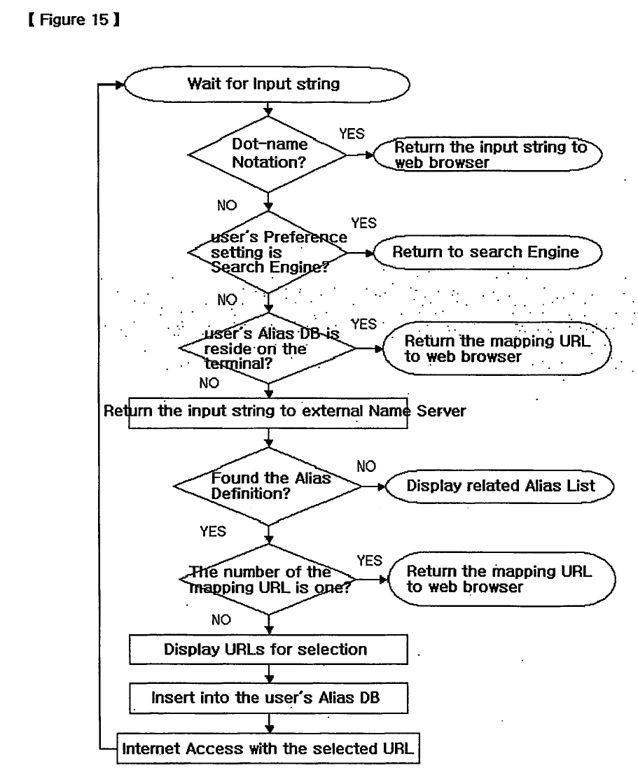

FIG. 16 shows user selection keyword service system.

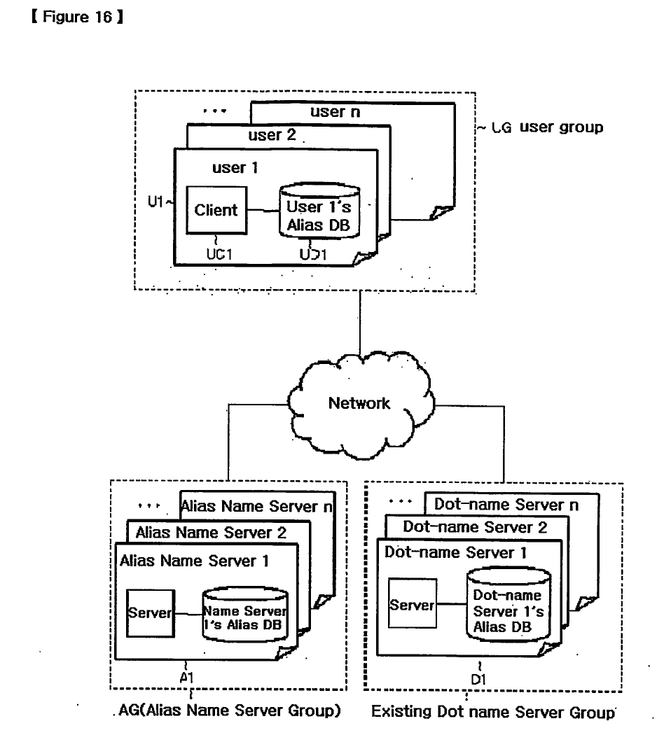

FIG. 17 shows mapping flow between E-mail Address & URL.

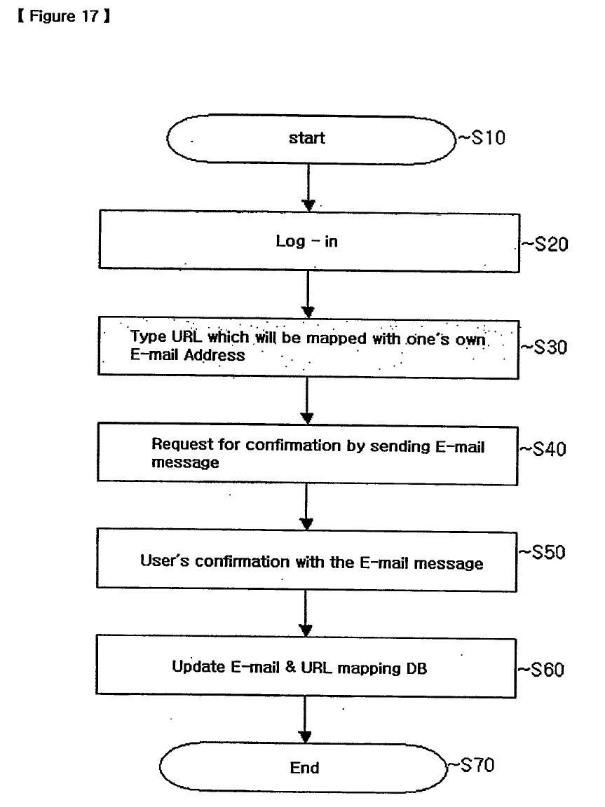

FIG. 18 shows processing flow of mapping between E-mail Address & URL.

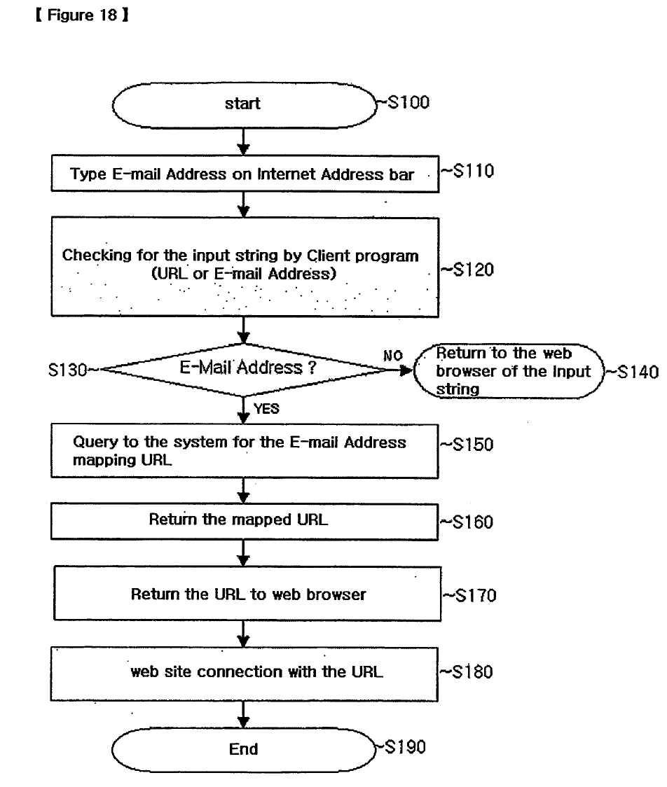

FIG. 19 shows an example of execution mode of web site connection using E-mail address.

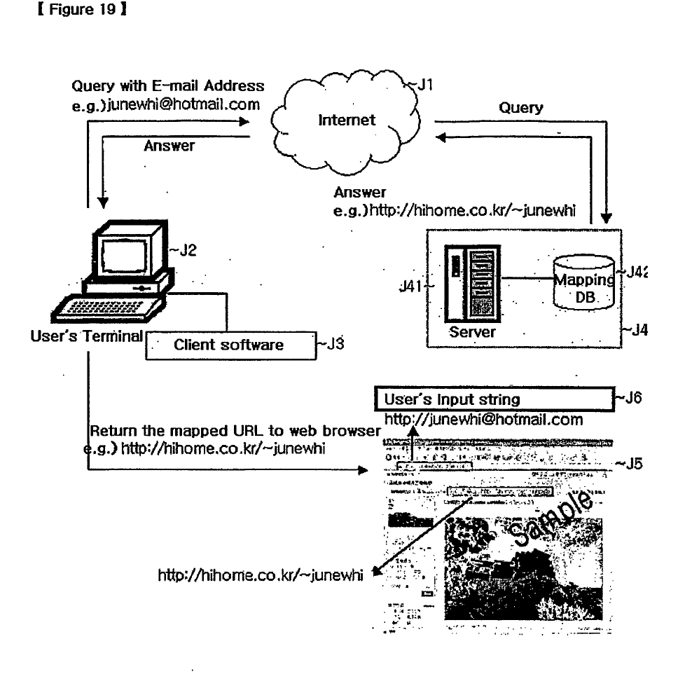

UC: Client
UD: User's Alias DB
UT: User's Terminal
WB: Web Browser/Internet Tool
UG: User Group
AG: External Alias Name Server Group
DG: Existing Dot-name Server Group
UC1: Client on User's Terminal
UD1: User's Alias DB on User's Terminal
S10, S20, S30, S40, S50, S60, S70: Each processing steps for Mapping DB
S130: Step for determining the Input string whether it is E-mail Address
S100, S110, S120, S140, S150, S160, S170, S180, S190: Each processing steps for mapping E-mail address & URL
J1: Internet/Network
J2: User's Terminal
J3: Client Software
J4: Conversion System
J41: Conversion System Server
J42: Mapping Database
J5: Web Browser Window
J6: E-mail Address of User-input
J7: URL mapped with input E-mail Address

### BEST MODE

Execution of this invention will be best when performed in tool-bar form in web browser where user-interface is equipped in user's terminal because basic concept of this invention is to enable web-surfing user to navigate freely by using his own definition and selection in his language. For instance, providing keyword window at tool bar installed in web browser with a few menu. The desirable model would be similar with the following. The tool bar embedded in the web browser will provided keyword window, in addition to a number of menu buttons next to it providing respective functions. Keywords obtained from a web page will be appeared in the keyword window, and this enables the users to search more or move to another site. Also, the program and database for keyword processing should be integral to the terminal of the user. This invention will provide faster access on the web since it does not require external servers for keyword processing.

### Mode for Invention

Method and system presented in this invention can make tool bar in users' terminal to offer user interface and can execute separately for each function. Besides toolbar, separate web site can provide service, or service can be provided by installing software in addition to web browser in users' terminal. Separate web site provides user interface screen as portal sites do and offers users' definition of keyword or selection and mapping information of e-mail and URL. In this case, users' information about these item is stored in relevant web site server mentioned above, not in users' terminal. Users provide this service by menu presented in web site and users' database that web site stores. And users' database and keyword processing program can be located on both users' terminal and web site. Execution in several forms besides interface and composition forms can be possible. Description is done about web browser in present Internet circumstance. But thought of this invention can be applied to new tool if Internet access tool is changed or new tool is used. And keyword about each document in web site can be extracted from meta tag of relevant document, title, URL, or contents. Users' keyword is words that they define or input. The most representative are search word and word to input in address bar for keyword service. Therefore users' keyword is string that they input and the string input in search engine is representative users' keyword. There can be a form of execution that chooses the string input in search engine by users as their keyword and presents related keyword for the string.

### INDUSTRIAL APPLICABILITY

This invention is useful for Internet beginners and users whose first language is not English. And users who can use English and Internet easily utilize this invention for approaching sites they often visit and searching and approaching related sites by keyword. Users definition keyword in this invention can diminish keyboard inputting by making alias for web site that users usually visit with name that they can easily input and remember. And by keyword system offered by existent service company connection to sites that users do not want can happen because their age or Internet usage are not reflected. Using alias instead of dot name in marking Internet address is more convenient for beginning Internet user or young students. Users' definition of sites that they visit many times can prevent side effect that is caused by one-sided alias registration of service company and decrease problems which are related to pre-occupation or violation of rights related to cover on Internet. And users can increase connectivity to sites they want and speed of connection to the sites can be increased because connection does not pass name server by using UD of UT.

And in this invention, a method and system that can store many keywords together with users' selection of keyword group are described. It can diminish discomfort that users define each keyword of many sites and make users to approach with keyword used in general without defining. There are sites that companies mainly use for their business, sites to cut off for security of company or character of works, sites that general users expect to approach according to their age or Internet usage and sites that they do not want to approach. Using alias instead of dot name in marking Internet address is more convenient for beginning Internet user or young students. Users' selection can prevent side effect that is caused by one-sided alias registration of service company. And users can increase connectivity to sites they want and speed of connection to the sites can be increased because connection does not pass name server by using UD of UT. Dynamic keyword extracted and processing this invention presents decreases discomfort that users input keyword or URL in web browser address bar to approach web site and input URL or search for related site from the first whenever they do not want accessed site or have to move to another related site. And it can search for web site that has high possibility of being visited by users and prepare related words in users' terminal. Also it can decrease time and efforts to input URL, to search repeatedly, or to navigate.

According to method of mapping and changing of e-mail address and URL presented by this invention, in case an actual Internet address is defined in other's e-mail address, users can access to other's homepage without memorizing address of it by only inputting e-mail address with conversion system and client software. Especially effort and expense to get domain for individual homepage and maintain it can be diminished. If they write e-mail address in message or name card, there is no need to mark users' homepage address because e-mail address is generalized and Internet address can be marked by e-mail address. If blog and individual homepage address is used for access by marking them as they are equal to e-mail address, individual homepage and blog become easy to use, exchanging information becomes convenient and simple, and violation of rights by similar domain or pre-occupation of domain name can be prevented.

1. Method for dynamic keyword extraction and processing, comprising of: (a) Hooking users input string from Internet address bar of web browser or Internet tool; (b) Extracting users keyword from the users input string; (c) Retrieving the related keywords of the extracted keyword by using dictionary database or keyword database of search engine; (d) Displaying the extracted keyword or the related keywords or processed keywords. (e) Execute web site connection or display related keywords.

2. The method of claim 1, wherein said the extracted keywords or related keywords or processed keywords includes at least one of followings: a separated level string of URL, a search word, and a keyword domain string.

3. A system for providing dynamic keyword extraction and processing includes following program modules: (a) A module for user's input string that is entered or displayed in address bar of web browser or Internet tool; (b) A module that parses the input string and determine the keyword from the parsed input string; (c) A module that processes extracted keyword; (d) A database for keyword processing as is retrieving related words; (e) A module for user interface which defines the keyword processing rules set by user; (f) A module which executes further search in search engine or web site connection according to the keyword processing rules.

4. The system of claim 3, the arrangement of each module and database are as followings: (a) The modules and database are located in user's terminal; (b) The modules and database are located in an external server which are connected with the user's terminal by Internet; (c) Some part of the module and database are located in an external server and the other part and database are located in user's terminal.

5. The system of claim 3, wherein said the module that parses the input string and determine the keyword from the parsed input string, determines the input string as a keyword if the input string is not including dot and determines the input string as a URL if the input string includes dot; the module classifies the URL string into top level domain, 2.nd level domain, 3rd level domain, 4th level domain; And the module abstracts keyword from 3rd level domain and region information or category information of web site from top or 2nd level domain.

6. The method of claim 1, keyword display window or tool bar includes plug-in program; Keyword extraction and processing method includes a form of pop-up window or dialog box displaying separately from web browser or Internet tool.

7. The method of claim 1, the method of dynamic keyword extraction and processing displays the extracted keyword and processed keyword in the form of as followings: A form of keyword, a translated word of other languages, abbreviation, antonym, synonym or keyword of search result of search engine; It includes category information extracted form each level domain of string besides keyword in object to process and display; In displayed string, displaying that helps users search newly using processed string and displays pop-up menu or toolbar menu for execution of search and instant opening is included; Users can add, delete, correct words they want about processed and presented string using the functions.

8. The method of claim 7, includes followings: Search engine in method of claim includes utilizing DB in users' terminal, DB for specific search engine, or DB of specific server; And displaying the search result of search engine as it is when displaying to users in a processed form; A method that starts search at the step of abstracting keyword without users' search for keyword and processes with users' web site navigation; And prepares lists pre-searched results for relevant keyword when users click keyword display window or toolbar is included.

9. The method of claim 1, includes followings: When it is difficult to abstract keyword only with 3rd lever domain string that composes URL string, (a) A method that abstracts keyword for string of relevant URL using abbreviate word database or dictionary database; (b) When HTML source of web site page that users visit has meta tags, a method to abstract words that compose meta title string as keyword; (c) A method that abstract frequently used words as keyword from web site page that users visit; (d) A method that sends whole URL string input or displayed in web browser address bar to search engine and abstracts keyword from name of relevant URL and explanation.

10. The method of claim 1, it includes abstracting keyword, searching with words related to keyword and collecting search result is processed at the same time with web browser and Internet search engine; Searched result of words related to the keyword extracted by users are stored by temporary storing directory, cookie, file, and database before users start to search; When they need search result, related words, or related sites list, searching and preparing sources for those is done.

11. Method for user oriented keyword definition and keyword navigation using each user's own keyword definition for web site address or URL, comprising of: (a) User defines Internet address or URL as user's own alias that is easy to remember and type in for the user; (b) The user stores the alias information in user side Internet terminal (UT) or external alias name server in the form of database; (c) User can update, add, or delete the keyword definition database as needed.

12. The method of claim 11 includes followings: In domain alias definition method that supports users' repeated approach to Internet using alias they define for web site that marks its Internet address as domain name, IP address, or URL; A step that users define alias they can use easily for specific web site and input alias; A step that adds input alias of users and one thing from domain of specific web site, IP address or URL which correspond to it to users' alias record as separate alias record and stores them; A step that makes it possible to add, change, and delete stored users' alias name database; A step that users define specific web site mentioned above as alias they can easily use and input alias is the one that they visit specific web site using web browser or Internet tool; A step that users web site, IP address or URL which correspond to it to users' alias record as separate alias record and stores them; is the step that alias processing program connects users alias database; A step that stores with one thing from input alias, domain name, IP address, or URL of web site, A step that makes it possible to add, change, and delete stored users' Alias database is the step that opens alias database editor to users by their request; A step that outputs users alias database stored in users to screen; A step that users change or delete Alias record of a specific item in users alias database; A step that reflects contents added, changed, and deleted by users into users alias database and stores.

13. The method of claim 12 includes followings: Storing location of users alias DB in domain alias definition method by users' definition follows a method to store directly in users' terminal or a method to store in external server connected to users' terminal by Internet.

14. The method of claim 12 includes followings: users designated name server for alias to use about items that are not in their alias database; And users alias database is used first; For definition that is not in users alias DB, service provided by name server designated by users are used together.

15. The method of claim 11, users' methods of alias DB composition are as followings:
a) A method that users list examples of alias and choose relevant list or list group and download all of chosen list group;
b) Users designate update time interval and field of update in name server designated by them; And when relevant items are changed in name server, program of users' terminal checks the changed items by time interval designated by users and updates automatically users alias DB stored in users' terminal or server designated by users; c) A method that users visit relevant site and they define alias for the page they are visiting and input the alias;
d) A method that users input themselves into alias DB using editor;
e) A method that users add alias definition menu in mouse click button and input relevant site among several sites searched by alias with search engine;
The methods above can be applied to adding, changing and erasing alias DB composed by users.

16. The method of claim 11, users' methods of alias DB composition are as followings: Users designate name server for alias to use about items that are not in their alias DB And users alias DB is used first; For definition that is not in users alias DB, service provided by name server designated by users are used together.

17. The method of claim 11, alias defined by users for Internet address is composed of combination of all letters and numbers which can be input in users' terminal; Users can define e-mail address and telephone number and use them.

18. The method of claim 11 include followings: If string input in Internet address bar is not Internet address in a form of existent dot name marking, processing method for this is searched by search engine and Internet address connection or not processed is presented separately; Users can choose and define; Field they do not want and processing it are presented to them The dynamic keyword processing method and system include a method that makes users to store items they chose in their terminal or server and user interface.

19. The method of claim 11 includes selective service method of users alias server and interface for it Those are as followings: Sites registered in users alias DB are classified into some groups by users' age, harmfulness of the sites, relation and commerce; Name servers for alias are arranged in couples and field of alias of each name server's service is presented; Consequently, users can choose name server that is appropriate for them.

20. The method of includes a method and interface for it; Those are as followings: Users choose alias list that is possible to be visited often by them, download it, and store it in their terminal or server they designate; Before searching alias input in address bar by users for access to Internet in external name server, the alias is searched in users alias DB in users' terminal first; For alias frequently used, users can get an actual Internet address for alias without passing external alias server and run web browser and Internet tool.

21. The method of claim 20, if alias input string by users are not in relevant name server or not in field that users want, the string is marked before approaching relevant address and list of other related site is output; Users can decide to advance, approach another related sites, or search for new sites for alias.

22. The method of claim 20, words not limited to a specific person like general noun, names of region, people and words not registered in the Trademarks act are registered in alias server; When users approach for the first time, additional explanation for these is presented and listed in couples; And users can choose site that they will user for relevant alias later User's selection is stored in alias DB of users' terminal and they can relevant alias.

23. The method of claim 22, when alias is registered in name server DB, about alias that can be registered in couples and cannot be insisted by a specific person, fields like Internet address of each site, explanation for relevant site, reason for alias, relation, commerce, relevant category, and age limit of users are added. For one alias, many different Internet address sites are registered.

24. A method of e-mail address and Internet address conversion, comprising of: When e-mail address, not Internet address, appears in Internet address bar, client software installed in users' terminal asks server, uses an actual Internet address for relevant e-mail address and runs users' web browser or Internet tool. Users can access an actual Internet address that corresponds to e-mail address by using the e-mail address.

25. A system of e-mail address and Internet address conversion, comprising of: It has mapping database in which e-mail address of users and actual Internet address that corresponds to it; Using this mapping database, they answer to a question of an actual Internet address by e-mail address in users' terminal. And they make, update, add, and delete mapping database.

26. The method of claim 24 include: Hooking users input string from address bar of web browser or Internet tool; determine the input string if it is e-mail address or Internet address; If the input string is e-mail address, send it to conversion system which has mapping database of e-mail address and URL; Run the web browser with an actual Internet address using internet address mapped in e-mail, IP address, domain name, or URL; And they include client software that offers user interface to define URL, and users' e-mail address and Internet address in mapping database of conversion system.

27. The method of claim 26, include method which determines e-mail address by checking the input string is including “@” or not; If the input string has “@”, it will be considered as e-mail address; the determination of e-mail address is executed by the client software in user side Internet terminal.

28. The method of claim 26, includes client software in users' terminal is written as apart of operation system program, in a form that moves with plug-in in web browser or in a form of toolbar for access to Internet; also includes a method that client software is installed or updated together in case of installing or updating the programs.

29. The method of claim 24, wherein said include: A step that users select or designate Internet address of the e-mail conversion system.

30. The method of claim 24, include: a way of translating e-mail address and Internet address used in a general form defined by international standard naming scheme and a form that is different to it, e-mail address is changed into an actual Internet address.

31. The method of claim 24, client software and conversion system are located in one system connected by Internet and translate the e-mail address input string into actual Internet address or URL that corresponds to the e-mail and URL mapping database of conversion system.
